(19) United States
(12) Patent Application Publication
(10) Pub. No.: US 2009/0135299 A1
(43) Pub. Date: May 28, 2009

(54) METHOD FOR PROCESSING A DIGITAL VIDEO STREAM AND CORRESPONDING DEVICE

(75) Inventors: Fritz Lebowsky, Saint Martin D'Uriage (FR); Sebastien Marsanne, Meylan (FR)

Correspondence Address: DOCKET CLERK, P.O. DRAWER 800889, DALLAS, TX, 75380, US

(73) Assignee: STMicroelectronics (Grenoble) SAS, Grenoble (FR)

(21) Appl. No.: 12/258,168

(22) Filed: Oct. 24, 2008

(30) Foreign Application Priority Data
Oct. 25, 2007 (FR) 07-58583

(51) Int. Cl. H04N 7/01

(52) U.S. Cl. 348/441; 348/E11.021

(57) ABSTRACT

According to this method for processing a digital video stream of colour images intended to be displayed on a matrix screen formed of macropixels having at least four subpixels each, the colour components of each image are transformed into an RGB format based on a polygonal representation of the colour components, and designed for the display of images using at least four colours by activating the four subpixels. The colour components of the image are adapted in the course of said transformation.

### CROSS-REFERENCE TO RELATED APPLICATIONS

The present application is related to French Patent Application No. 07-58583, filed Oct. 25, 2007, entitled “METHOD FOR PROCESSING A DIGITAL VIDEO STREAM AND CORRESPONDING DEVICE”. French Patent Application No. 07-58583 is assigned to the assignee of the present application and is hereby incorporated by reference into the present disclosure as if fully set forth herein. The present application hereby claims priority under 35 U.S.C. §119(a) to French Patent Application No. 07-58583.

### TECHNICAL FIELD

The present disclosure relates, in a general manner, to the processing of colour digital images with a view to display on a matrix screen, that is, a screen consisting of rows and columns. These screens are preferably flat, active-matrix screens.

The present disclosure relates more particularly to images represented in a format called standard RGB or having been transformed into this format.

### BACKGROUND

Conventionally, images delivered by a video processor are processed by a display processing unit (DPU), then transmitted to a means of controlling the columns of the screen incorporated into a means of electronically controlling the display (DDE, for display driver electronics).

U.S. Pat. No. 6,930,691 in the name of STMicroelectronics Inc. describes a transformation of colour components of a digital image from a standard RGB format to another RGB format based on a polygonal representation.

This transformation allows an image to be displayed using six colours: yellow, red, green, blue, cyan and magenta. This six-colour image display is carried out on a suitable screen. However, the quality of the displayed image is not straightforwardly reproducible from one screen to another.

Furthermore, the display of an image on a matrix screen formed of macropixels having at least four subpixels each and with an independent signal for each subpixel, according to the same mode of control as a matrix screen formed of macropixels having three subpixels each with the colours red, green and blue, in particular with three independent signals, would generate proportionally increased power dissipation, proportionally increased bandwidth and proportionally increased electromagnetic interference.

This would become unacceptable for screens of large size or High Definition (HD) format screens, for example of macropixels, or even for the small screens of portable systems for which the power dissipation constraints are compounded.

### SUMMARY

According to one embodiment, a method is proposed comprising a transformation of an image from a first into a second RGB format based on a polygonal representation, allowing an excellent quality image to be obtained no matter which display screen is used.

According to a first aspect, a method is proposed for processing a digital video stream of colour images intended to be displayed on a matrix screen formed of macropixels having at least four subpixels each, each of the images comprising three colour components in a first RGB format, the method comprising a transformation of the colour components of each image into a second RGB format based on a polygonal representation of the colour components and designed for the display of images using at least four colours by activating the four subpixels.

According to a general feature of this method, the colour components of the image are adapted in the course of said transformation.

Thanks to the adaptation of the colour components of the image, it is possible to adapt the colour components to the technical characteristics of a processing system incorporating the method.

In one implementation, the RGB components for each image are transformed based on the equations:

CR=f₁(R,G,B,Δ₁),

CG=f₂(R,G,B,Δ₂), and

CB=f₃(R,G,B,Δ₃)

where:

CR, CG and CB are the transformed RGB components;

f₁, f₂, and f₃ are the functions for transformation into said second RGB format for each RGB component;

R, G and B are the three colour components in said first RGB format of the image; and

Δ₁, Δ₂ and Δ₃ are parameters representing the technical characteristics of a processing system implemented to display the images, for each transformed component of the image considered.

According to another feature of this method, it furthermore comprises, for each image, working out a control signal for each column of the screen based on the transformed colour components, each control signal comprising at least four distinct components to activate the corresponding subpixels.

For example, each control signal is capable of activating six subpixels to display six colours, that is:

three main colours: red, green, blue, and

three secondary colours: yellow, cyan, magenta.

It should be noted, however, that the choice of colour coordinates in the RGB format is in no way limiting. In other words, the colour yellow can, for example, resemble every shade between the colours red and green.

For example, for each image at the end of the transformation the procedure is:
encoding then transmission of each of its transformed colour components;
reception then decoding of each of its transformed colour components; then

working out the control signals for the columns of the screen, said working out comprising:
working out the control signal component to activate the subpixel corresponding to the colour yellow by finding the minimum among the received and decoded red and green colour components;
working out the control signal component to activate the subpixel corresponding to the colour cyan by finding the minimum among the received and decoded green and blue colour components; and
working out the control signal component to activate the subpixel corresponding to the colour magenta by finding the minimum among the received and decoded red and blue colour components.

In one implementation, the method furthermore comprises for each image at the end of the transformation:
determination on the basis of the three transformed colour components, forming three main colour components, of three secondary colour components;
a first encoding of the three main colour components, in the course of which each main colour component is associated with a secondary piece of information representing the value of at least one secondary colour component;
a second encoding and transmission of the encoded three main colour components according to a standard called PPDS (Point to Point Differential Signalling);
reception of the encoded three main colour components and decoding of the main colour components received, in the course of which each piece of secondary information is read so as to generate a secondary signal representing the secondary colour components;

said working out of the control signal for the columns of the screen then comprising:
working out the control signal component to activate the subpixel corresponding to the colour yellow by using the adapted secondary signal to select the minimum among the received and decoded red and green colour components;
working out the control signal component to activate the subpixel corresponding to the colour cyan by using the adapted secondary signal to select the minimum among the received and decoded green and blue colour components;
working out the control signal component to activate the subpixel corresponding to the colour magenta by using the adapted secondary signal to select the minimum among the received and decoded red and blue colour components.

According to a second aspect, a device for processing a digital video stream is also proposed, comprising a processing system connected to a matrix display screen formed of macropixels having at least four subpixels each, said video stream being formed of colour images, each comprising three colour components in a first RGB format, said processing system comprising a means of transforming the colour components of each image into a second RGB format based on a polygonal representation of the colour components, such that the display screen is capable of displaying images using at least four colours resulting from the activation of four subpixels.

According to a general feature of this device, the transformation means includes means for adapting the colour components of each image to the technical characteristics of the processing system.

For example, said transformation means comprises three modules respectively associated with three transformation functions, each module being able to transform an RGB component of an image from the first to the second format, such that:

CR=f₁(R,G,B,Δ₁),

CG=f₂(R,G,B,Δ₂), and

CB=f₃(R,G,B,Δ₃)

where:

CR, CG and CB are the RGB components transformed by each of said modules;

f₁, f₂, and f₃ are said transformation functions;

R, G and B are the three colour components in said first RGB format of the image considered; and

Δ₁, Δ₂ and Δ₃ are parameters representing the technical characteristics of the processing system, for each transformed component of the image considered.

This device may furthermore comprise a means for controlling the columns of the matrix screen, able to work out a control signal for each column of the screen based on the transformed colour components, each control signal comprising at least four components to activate the corresponding subpixels.

For example, each control signal comprises six components so as to activate six subpixels for the display of six colours, that is:

three main colours: red, green, blue, and

three secondary colours: yellow, cyan, magenta.

Said processing system may comprise:
a processing unit that incorporates said transformation means and a transmission means able to encode and to transmit each of the transformed colour components;
a means for controlling the display which comprises:
a reception means able to receive and to decode each of the transformed colour components; and
said means of controlling the columns of the matrix screen, connected at the output of the reception means, comprising:
a first sub-means capable of working out the control signal component to activate the subpixel corresponding to the colour yellow, by finding the minimum among the red and green colour components received and decoded;
a second sub-means capable of working out the control signal component to activate the subpixel corresponding to the colour cyan, by finding the minimum among the green and blue colour components received and decoded; and
a third sub-means capable of working out the control signal component to activate the subpixel corresponding to the colour magenta, by finding the minimum among the red and blue colour components received and decoded.

According to another characteristic of the device, said processing system may comprise:
a processing unit which incorporates:
said conversion means;
an intermediate unit connected at the output of the transformation means, able to determine on the basis of the three transformed colour components, forming three main colour components, three secondary colour components;
a transmission means capable of encoding the three main colour components, in particular by associating them with a secondary piece of information representing the value of at least one secondary colour component, and able to transmit the encoded three main colour components according to a standard called PPDS;
a means for controlling the display which comprises:
a reception means able to receive the encoded three main colour components, and able to decode the main colour components received, by reading each piece of secondary information so as to generate a secondary signal representing the secondary colour components; and
said means of controlling the columns of the matrix screen, connected at the output of said reception means, comprising:
a first selector capable of working out the control signal component to activate the subpixel corresponding to the colour yellow by using the corresponding secondary signal to select the minimum among the decoded red and green colour components;
a second selector capable of working out the control signal component to activate the subpixel corresponding to the colour cyan by using the corresponding secondary signal to select the minimum among the decoded green and blue colour components; and
a third selector capable of working out the control signal component to activate the subpixel corresponding to the colour magenta by using the corresponding secondary signal to select the minimum among the red and blue colour components received and decoded.

According to a third aspect, a system comprising a display screen, for example a television, incorporating a device such as described above is also proposed.

Other technical features may be readily apparent to one skilled in the art from the following FIGURES, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 shows a flow chart illustrating an implementation of the method according to a first aspect;

FIG. 2 shows an embodiment of a system incorporating a device according to the second aspect;

FIG. 3a illustrates an example of a macropixel incorporated within the screen, connected to the device illustrated in FIG. 2;

FIG. 3b illustrates another example of a macropixel incorporated within the screen, connected to the device illustrated in FIG. 2;

FIG. 4 illustrates an embodiment of a transformation means incorporated in the devices of FIG. 2;

FIG. 5a illustrates an embodiment of a means for controlling the columns of a screen such as illustrated in FIG. 2;

FIG. 5b illustrates another embodiment of a means for controlling the columns of a screen such as illustrated in FIG. 2;

FIG. 6 illustrates another embodiment of a processor such as shown in FIG. 2;

FIG. 7 illustrates an embodiment of a display control means working together with the processor shown in FIG. 6; and

FIG. 8 shows an embodiment of a selector incorporated in a display control means such as shown in FIG. 7.

### DETAILED DESCRIPTION

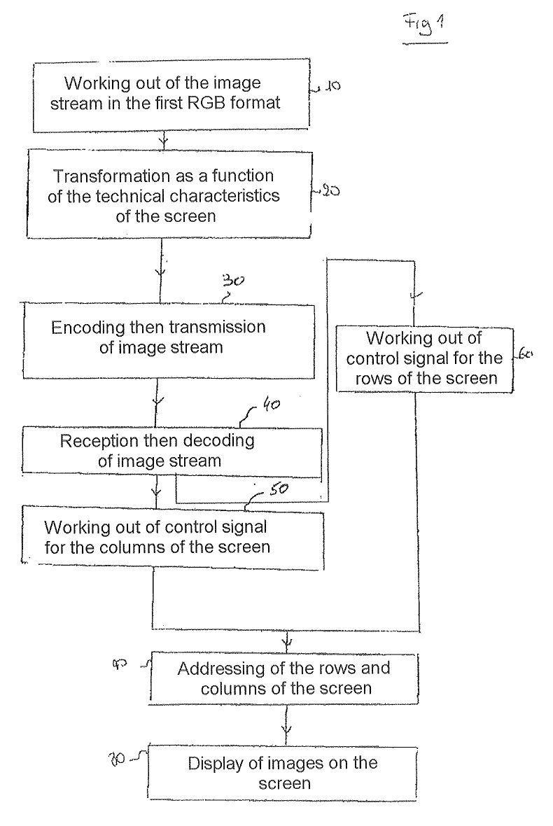

Reference will be made at present to FIG. 1, which shows, in a very simplified manner, a flow chart which recalls the various steps of a method for processing a video stream according to a first aspect. This video stream is formed of a series of colour digital images.

In the course of a first step 10, the image stream is worked out in a first RGB format, for example using a video processor. If this image stream is not in an RGB format, a conversion is first carried out from this other format (for example a YUV format) to an RGB format, referred to as the first RGB format.

This first RGB format is a standard RGB format well known to a person skilled in the art.

The images are then transformed into a second RGB format based on a polygonal representation of the colour components (step 20). This second RGB format is described in the U.S. Pat. No. 6,930,691 in the name of the applicant.

Besides the steps described in the U.S. Pat. No. 6,930,691, this transformation includes an adaptation of the new RGB components to the technical characteristics of the video stream processing system. This is because these technical characteristics tend to impair the brightness of the image, or the saturation of certain colours, or even the shade of certain colours. Adapting the components modifies the new RGB components so as to compensate for an impairment of the image due to technical characteristics of the video stream processing system.

How these technical characteristics are taken into account will be described in more detail below.

In the course of the following step 30, the image stream is encoded and transmitted to be converted into a control signal for the columns of the screen. The encoded images are thus received and then decoded, step 40.

Then the control signal is worked out for each column of the screen (step 50), so as to allow activation of the pixel situated at the intersection of the row and the column considered. The activation of the pixel will be described in more detail subsequently.

In the course of a step 60, in parallel to the step 50 of working out the control signal for the columns of the screen, the control signal for the rows of the screen is worked out. Conventionally, in the case of an active matrix screen, at the moment the image is displayed, the rows of the screen are selected one by one, then for each selected row the control signals will be sent to the columns of the screen so as to display the image considered.

Once the different control signals for the rows and the columns have been worked out, the rows of the screen are addressed row by row, then for each selected row the columns are addressed (step 70).

Finally, once the rows and the columns have been addressed, the image is displayed (step 80).

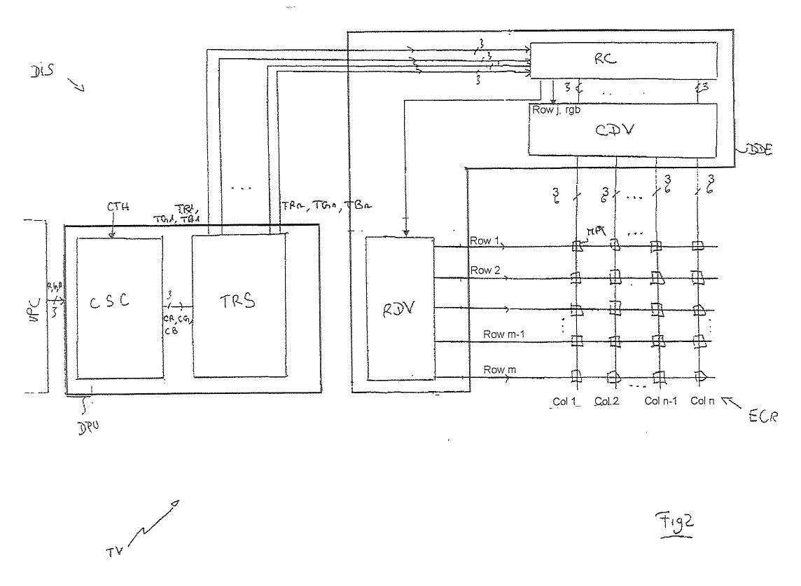

Reference will be made at present to FIG. 2, which illustrates a television TV incorporating a matrix screen ECR connected to a digital video stream processing device DIS. The television TV is offered here by way of example. The person skilled in the art will know how to incorporate a digital video stream processing device DIS into any other system having a matrix display screen.

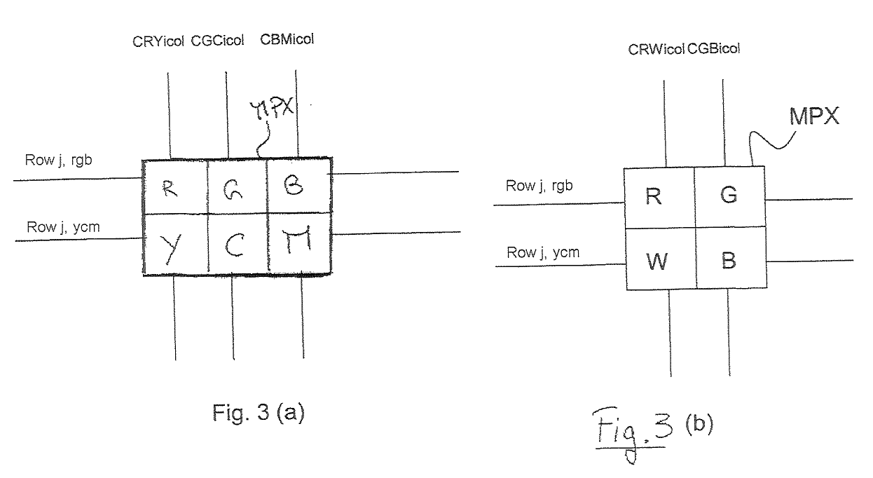

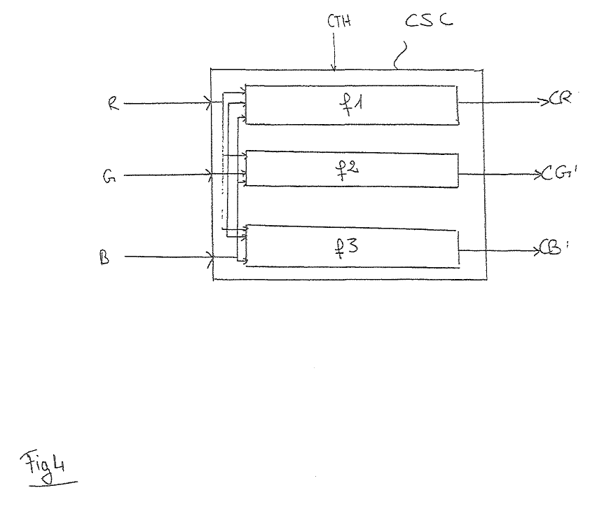

The screen ECR is a matrix screen known as an active matrix screen. It is formed of rows and columns, at the intersection of which a macropixel MPX is situated. This macropixel MPX is represented in FIG. 3a. Here it is formed of six parts or subpixels, each allowing the very precise display of one colour, respectively red R, green G, blue B, yellow Y, cyan C and magenta M. As can be seen, each macropixel MPX is addressable by control signals row j, rgb; row j, ycm; CRY_{icol}; CGC_{icol}; and CBM_{icol}. The colours red, green and blue are called main colours, while the colours yellow, cyan and magenta are the secondary colours. Generally speaking, a macropixel is formed of at least four subpixels. Thus, the subpixels may also correspond to three main colours to which a white subpixel W is added, as illustrated in FIG. 3b. As previously, the macropixels are addressable by control signals, here marked row j, rgb; row j, ycm; CRW_{icol} and CGB_{icol}. The use of macropixels instead of standard pixels (with three subpixels for the three main colours) allows optimal image quality with colours close to the real colours.

Referring again to FIG. 2, the device DIS comprises a processing system formed, in particular, of a video processor VPC, a processing unit DPU, and a display control means DDE.

The video processor VPC delivers a digital video stream formed of colour images in a standard RGB format. Consequently, each image is formed of three colour components, red R, green G and blue B, respectively.

For each image, these three components are delivered to the processing unit DPU.

This processing unit DPU has a transformation means CSC which, besides the colour components of images in a standard RGB format, receives data CTH modelling the various technical characteristics of the processing system of the device DIS. More precisely, the data CTH represent the distortion of the image colours caused by the processing system. For example, the choice of optical filter for the colour red may cause a modification of the red, green and blue components of the image. Similarly, the choice of optical filter for the colour green may cause a modification of the red, green and blue components of the image. The choice of optical filter for the colour blue may similarly cause a modification of the red, green and blue components of the image. The choice of optical filter for the colour yellow may in addition cause a modification of the red, green and blue components of the image. The choice of optical filter for the colour cyan may also cause a modification of the red, green and blue components of the image. The choice of optical filter for the colour magenta may similarly cause a modification of the red, green and blue components of the image. In the case where there is no corresponding colour filter for the colour white, the choice to pass through a white subpixel may cause a modification of the red, green and blue components of the image.

The transformation means CSC transforms the components of each image from the standard RGB format (first RGB format) into a second RGB format based on a polygonal representation of the colour components, such as described in the U.S. Pat. No. 6,930,691. In addition, this transformation includes an adaptation of the new colour components to the various technical characteristics of the processing system, based on the data CTH.

At the output of the transformation means CSC, each image comprises three colour components CR, CG and CB in the second RGB format, such as described above, with an additional adaptation to the technical characteristics of the processing system.

For each image, these three components CR, CG and CB are transmitted to a transmission means TRS. The latter is connected to the display control means DDE, which is able to control the columns of the screen ECR, n being the number of columns col 1, . . . , col n of the screen ECR, and the rows row 1, . . . , row m of the screen ECR, m being the number of rows of the screen ECR. The transmission has to transmit only three colour components TR1, TG1, TB1, . . . , TRn, TGn, TBn per row, which makes the transmission particularly fast.

The transmission is preferably carried out in a differential mode. For example, the encoding and the transmission may be carried out according to the LVDS (Level Voltage Differential Signalling), or RSDS (Reduced Swing Differential Signalling) or PPDS (Point to Point Differential Signalling) standard, or the like, which are well known to the person skilled in the art.

A receiver RC (reception means) incorporated into the display control means DDE receives the data according to the LVDS (Level Voltage Differential Signalling), or RSDS (Reduced Swing Differential Signalling) or PPDS (Point to Point Differential Signalling) standard, or the like, which are well known to the person skilled in the art. The receiver RC then decodes these data before sending them to a means for controlling the columns of the screen CDV. Note that the reception unit RC also controls a means of controlling the rows of the screen ECR, referred to as RDV, based on the horizontal and vertical synchronization signals, incorporated in the transmission means TRS. The means for controlling the screen RDV includes each subscripted row j (j being between 1 and m).

Based on these three colour components, the column control means CDV is able to work out, for each column, a control signal for each macropixel MPX situated in the activated row. An embodiment of the column control means CDV will be described in more detail below.

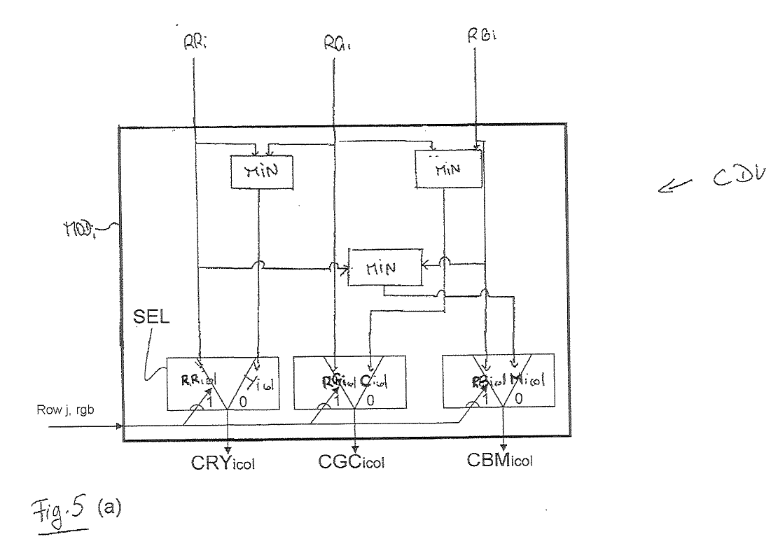

Reference will be made at present to FIG. 4, which illustrates an embodiment of a transformation means CSC. As explained above, for each image of the video stream it receives the three colour components R, G and B in a first, standard RGB format.

The transformation means also receives data CTH corresponding to different technical characteristics of the processing system. In this example the data CTH will be considered to represent the variations in brightness generated by the screen used for the different colours making up the displayed images.

The transformation means CSC comprises three modules, each being associated with a function f1, f2 and f3, respectively. The three modules receive the three colour components R, G, B in the first RGB format. The module associated with the function f1 provides the transformed red component CR, the module associated with the function f2 provides the transformed green component CG and the module associated with the function f3 provides the transformed blue component CB.

For example, the three transformed components CR, CG and CB may be worked out according to the three following functions:

CR=f1(R,G,B,Δ₁lum_{R},Δ₁lum_{G},Δ₁lum_{B},Δ₁lum_{Y},Δ₁lum_{C},Δ₁lum_{M}),

CG=f2(R,G,B,Δ₂lum_{R},Δ₂lum_{G},Δ₂lum_{B},Δ₂lum_{Y},Δ₂lum_{C},Δ₂lum_{M}),

CB=f3(R,G,B,Δ₃lum_{R},Δ₃lum_{G},Δ₃lum_{B},Δ₃lum_{Y},Δ₃lum_{C},Δ₃lum_{M}).

The variables R, G, B are the colour components received by the transformation means CSC, the variables Δᵢlum_{X} correspond to the aforementioned variations in luminosity.

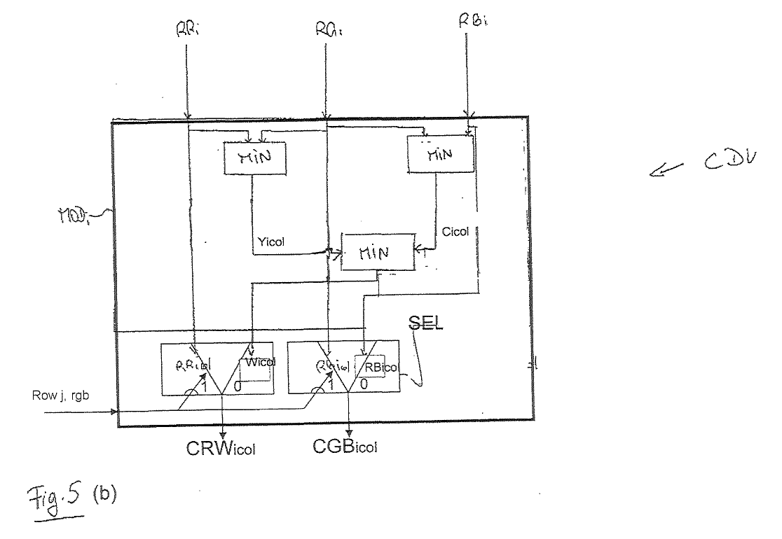

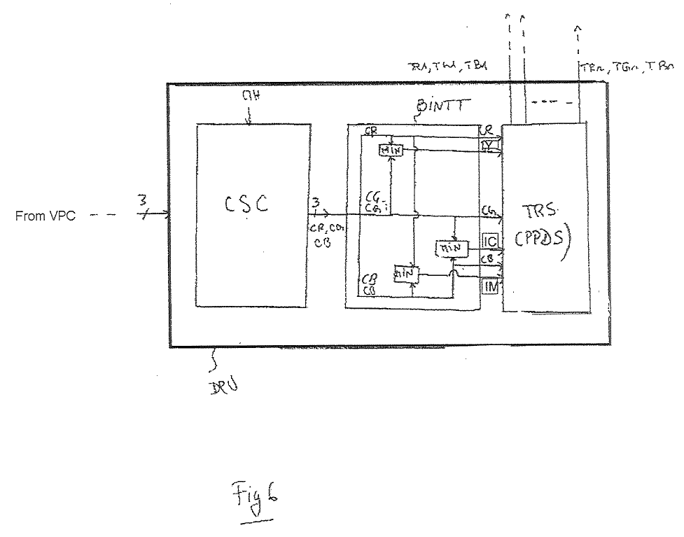

Reference will be made at present to FIG. 5a, which illustrates an embodiment of the means CDV of controlling the columns of the screen. The screen control means CDV comprises for each subscripted column i (i being between 1 and n) a module MODi able to generate the control signal for the column. Each control signal comprises six components RR_{iCOL}, Y_{iCOL}, RG_{iCOL}, C_{iCOL}, RB_{iCOL} and M_{iCOL} to activate respectively the six subpixels of the macropixel, red, yellow, green, cyan, blue and magenta, respectively.

To work out these control signals, the column control means CDV then receives as input the colour components of the image in the second RGB format, once these have been decoded by the receiver RC, and stores them with a storage means, preferably a register. The colour components decoded by the receiver RC are referred to as RRi, RGi and RBi.

The control signal components for activating the red, green and blue subpixels, RR_{iCOL}, RG_{iCOL} and RB_{iCOL} respectively, result directly from the components RRi, RGi and RBi.

The module MODi comprises three units MIN able to choose the minimum between two input values. The first unit MIN (first sub-means) receives the components RRi and RGi as input and generates as output the control signal component Y_{iCOL} which allows the yellow subpixel to be activated. The control signal component Y_{iCOL} therefore corresponds to the minimum between the signals RRi and RGi.

Similarly, another unit MIN (second sub-means) receives the green RGi and blue RBi components as input so as to provide the control signal component C_{iCOL} capable of activating the cyan subpixel.

Finally, a last unit MIN (third sub-means) receives the red RRi and blue RBi components as input and provides as output the control signal component M_{iCOL} capable of activating the magenta subpixel.

A macropixel with six subpixels is preferably defined by means of two rows of three columns of subpixels, as illustrated in FIG. 3a. A signal Row j, rgb (the subscript j being between 1 and m) generated in the receiver RC is used to control the selectors SEL (fourth to sixth sub-means). The first unit SEL (fourth sub-means) receives the components RR_{iCOL} and Y_{iCOL} as input and generates as output the component CRY_{iCOL} controlling the red subpixel when the row j, rgb is activated or controlling the yellow subpixel when the row j, ycm is activated.

Similarly, another unit SEL (fifth sub-means) receives the components RG_{iCOL} and C_{iCOL} as input and generates as output the component CGC_{iCOL} controlling the green subpixel when the row j, rgb is activated or controlling the cyan subpixel when the row j, ycm is activated.

Finally, a last unit SEL (sixth sub-means) receives the components RB_{iCOL} and M_{iCOL} as input and generates as output the component CBM_{iCOL} controlling the blue subpixel when the row j, rgb is activated or controlling the magenta subpixel when the row j, ycm is activated.

Reference will be made at present to FIG. 5b, which illustrates another embodiment of the means CDV of controlling the columns of the screen. The screen control means CDV comprises for each subscripted column i (i being between 1 and n) a module MODi able to generate the control signal for the column. Each control signal comprises four components RR_{iCOL}, RG_{iCOL}, RB_{iCOL} and W_{iCOL} to activate respectively the four subpixels of the macropixel, red, green, blue and white, respectively.

To work out these control signals, the column control means CDV then receives as input the colour components of the image in the second RGB format, once these have been decoded by the receiver RC. The colour components decoded by the receiver RC are referred to as RRi, RGi and RBi.

The control signal components for activating the red, green and blue subpixels, RR_{iCOL}, RG_{iCOL} and RB_{iCOL} respectively, result directly from the components RRi, RGi and RBi.

The module MODi comprises three units MIN able to choose the minimum between two input values. The first unit MIN (first sub-means) receives the components RRi and RGi as input and generates as output the control signal component Y_{iCOL} which allows the yellow subpixel to be activated. The control signal component Y_{iCOL} therefore corresponds to the minimum between the signals RRi and RGi.

Similarly, another unit MIN (second sub-means) receives the green RGi and blue RBi components as input so as to provide the control signal component C_{iCOL} capable of activating the cyan subpixel.

Finally, a last unit MIN (third sub-means) receives the yellow and cyan components Y_{iCOL} and C_{iCOL} as input and provides as output the control signal component W_{iCOL} capable of activating the white subpixel.

A macropixel with four subpixels is preferably composed of two rows of two columns, as illustrated in FIG. 3b. A signal Row j, rgb generated in the receiver RC is used to control the selectors SEL (fourth and fifth sub-means). The first unit SEL (fourth sub-means) receives the components RR_{iCOL} and W_{iCOL} as input and generates as output the component CRW_{iCOL} controlling the red subpixel when the row j, rgb is activated or controlling the white subpixel when the row j, ycm is activated.

Similarly, another unit SEL (fifth sub-means) receives the components RG_{iCOL} and RB_{iCOL} as input and generates as output the component CGB_{iCOL} controlling the green subpixel when the row j, rgb is activated or controlling the blue subpixel when the row j, ycm is activated.

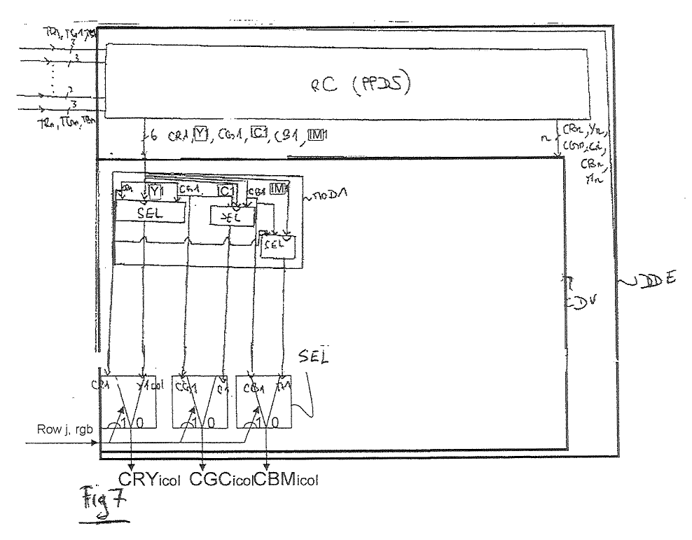

FIGS. 6 to 8 show variants of the processing system in the case where the transmission is carried out according to the transmission standard called PPDS (Point to Point Differential Signalling).

In this case, the processing unit DPU includes an intermediate unit BINTT connected between the transformation means CSC and the transmission means TRS which is itself adapted to the PPDS standard. For each image this intermediate unit BINTT receives the transformed colour components CR, CG and CB as input.

This intermediate unit BINTT comprises three units DMIN so as to generate the information components called information components for secondary colours, IY, IC and IM for yellow, cyan and magenta, respectively.

The secondary colour information component IY corresponds to a bit that signals the minimum between the red and green colour components CR and CG. The colour component IC corresponds to a bit that signals the minimum between the blue and green colour components CB and CG. Finally, the colour component IM corresponds to a bit that signals the minimum between the red and blue colour components CR and CB.

All these colour components CR, IY, CG, IC, CB and IM are provided by the transmission means TRS. The latter transmits data TR1, TG1, TB1, . . . , TRn, TGn, TBn to the receiver RC for each column numbered from 1 to n.

Each datum TRi, TGi, TBi respectively corresponds to the three transformed main colour components for the column numbered i, to which a secondary piece of information is attached. Although the primary information is composed of several bits, the secondary information corresponds to one or more additional bits allowing the value of a secondary colour component to be determined. In this way, if the yellow colour component corresponds to the red colour component, because the value of this component is less than the green component, then the variables TRi will have, for example, an additional bit equal to one so as to indicate that the yellow secondary colour component has the same value as the red main colour component. This is carried out for all the columns, for all the components and for all the images.

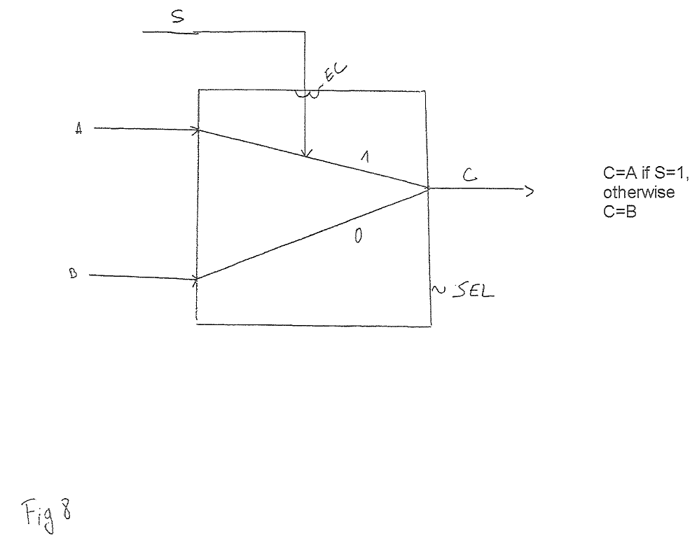

FIG. 7 illustrates a display control means DDE designed to the PPDS standard. In this case, the receiver RC is itself designed to the PPDS standard. It receives the data TR1, TG1, TB1, . . . , TBn, TGn, TBn as input and provides as output, for each column of the screen, the decoded red, green and blue main colour components, CRi, CGi and CBi, respectively, for a column i, along with secondary signals representing the secondary colour information components IYi, ICi, IMi for a column i. These secondary signals IYi, ICi, IMi are worked out as a function of the secondary information.

The modules MODi of the column control means CDV hence comprise selectors SEL in place of the units MIN from the embodiment of FIG. 5. For the first column, the selectors SEL of the module MOD1 respectively receive as input the colour components red and green, CR1 and CG1, green and blue, CG1 and CB1, and blue and red, CB1 and CR1. Each selector SEL is controlled by a control signal corresponding to the secondary signals IY1, IC1 and IM1, respectively.

Depending on the value of this control signal, the selector chooses one or the other of the colour components, such that the yellow, blue and magenta components respectively correspond to the minimum among the red and green components, the green and blue components, and the blue and red components.

The module MODi is repeated for each column and its working mechanism is identical for each of them.

As can be seen in FIG. 7, a selector SEL is again used to choose one or the other of the control signal components, namely CR1 or Y1col, CG1 or C1, CB1 or M1, to work out the signals, CRY_{icol}, CGC_{icol} and CBM_{icol}, respectively, for selecting the columns of the macropixel MPX (FIG. 3(a)).

FIG. 8 shows an example of a selector SEL incorporated into one of these modules. The latter receives two variables A and B as input, for example the red and blue colour components coming from the receiver RC. The selector EC comprises a control input EC which receives the previously mentioned control signal. The latter, worked out from a secondary piece of information, indicates whether the component A is less than or equal to the component B. If that is the case, the input A is connected to the output; if not, the input B is connected to the output. Preferably, for the control signal S a representative binary value is used, as is well known to the person skilled in the art, for example “1”, which indicates to the selector to connect the component A to the component C, and to connect the component B otherwise.

It will be noted finally that the previously described device and method apply equally well to fixed screens, of the video screen type, for example television sets or flat screens, as to screens of electronic equipment, whether portable or not, such as microcomputers, mobile telephones, or the like.

They therefore apply in a general manner to systems comprising a display screen in which processing of colour digital images is implemented.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for processing a digital video stream of colour images intended to be displayed on a matrix screen formed of macropixels having at least four subpixels each, each of the images comprising three colour components in a first RGB format, the method comprising:
a transformation of the colour components of each image into a second RGB format based on a polygonal representation of the colour components and designed for the display of images using at least four colours by activating the four subpixels, wherein said method being characterized in that the colour components of the image are adapted in the course of said transformation.

2. Method according to claim 1, in which the RGB components for each image are transformed based on the equations:
CR=f₁(R,G,B,Δ₁),
CG=f₂(R,G,B,Δ₂), and
CB=f₃(R,G,B,Δ₃)
where:
CR, CG and CB are the transformed RGB components;
f₁, f₂, and f₃ are the functions for transformation into said second RGB format for each RGB component;
R, G and B are the three colour components according to said first RGB format of the image; and
Δ₁, Δ₂ and Δ₃ are parameters representing the technical characteristics of a processing system implemented to display the images, for each transformed component of the image considered.

3. Method according to claim 2, further comprising: working out a control signal for each column of each image of the screen based on the transformed colour components, each control signal comprising at least four distinct components to activate the corresponding subpixels.

4. Method according to claim 3, in which each control signal activates six subpixels to display six colours, the six colours comprising three main colours red, green, blue and three secondary colours yellow, cyan, magenta.

5. Method according to claim 4, further comprising for each image at the end of the transformation:
encoding the transmission of each of its transformed colour components;
transmitting the transformed colour components;
receiving and then decoding of each of its transformed colour components; and
working out the control signals for the columns of the screen, wherein the working out comprising:
working out the control signal component to activate the subpixel corresponding to the colour yellow by finding the minimum among the received and decoded red and green colour components;
working out the control signal component to activate the subpixel corresponding to the colour cyan by finding the minimum among the received and decoded green and blue colour components; and
working out the control signal component to activate the subpixel corresponding to the colour magenta by finding the minimum among the received and decoded red and blue colour components.

6. Method according to claim 4, comprising for each image at the end of the transformation:
determining on the basis of the three transformed colour components, forming three main colour components comprising:
a first encoding of the three main colour components, in the course of which each main colour component is associated with a secondary piece of information representing the value of at least one secondary colour component;
a second encoding and transmission of the encoded three main colour components according to a standard called PPDS; and
reception of the encoded three main colour components and decoding of the main colour components received, in the course of which each piece of secondary information is read so as to generate a secondary signal representing the secondary colour components, wherein said working out of the control signal for the columns of the screen comprises:
working out the control signal component to activate the subpixel corresponding to the colour yellow by using the adapted secondary signal to select the minimum among the received and decoded red and green colour components;
working out the control signal component to activate the subpixel corresponding to the colour cyan by using the adapted secondary signal to select the minimum among the received and decoded green and blue colour components; and
working out the control signal component to activate the subpixel corresponding to the colour magenta by using the adapted secondary signal to select the minimum among the received and decoded red and blue colour components.

7. Device for processing a digital video stream, comprising:
a processing system connected to a matrix display screen formed of macropixels having at least four subpixels each, said video stream being formed of colour images, each comprising three colour components in a first RGB format, said processing system comprising a means of transforming the colour components of each image into a second RGB format based on a polygonal representation of the colour components, such that the display screen is capable of displaying images using at least four colours resulting from the activation of four subpixels,
said device being characterized in that the transformation means includes means for adapting the colour components of each image to the technical characteristics of the processing system.

8. The device according to claim 7, in which said transformation means comprises three modules respectively associated with three transformation functions, each module being able to transform an RGB component of an image from the first to the second format, such that:
CR=f₁(R,G,B,Δ₁),
CG=f₂(R,G,B,Δ₂), and
CB=f₃(R,G,B,Δ₃)
where:
CR, CG and CB are the RGB components transformed by each of said modules;
f₁, f₂, and f₃ are said transformation functions;
R, G and B are the three colour components in said first RGB format of the image considered; and
Δ₁, Δ₂ and Δ₃ are parameters representing the technical characteristics of the processing system, for each transformed component of the image considered.

9. The device according to claim 8, furthermore comprising a means for controlling the columns of the matrix screen, able to work out a control signal for each column of the screen based on the transformed colour components, each control signal comprising at least four components to activate the corresponding subpixels.

10. The device according to claim 9, in which each control signal comprises six components so as to activate six subpixels for the display of six colours, that is:
three main colours: red, green, blue, and
three secondary colours: yellow, cyan, magenta.

11. The device according to claim 10, in which said processing system comprises:
a processing unit that incorporates said transformation means and a transmission means able to encode and to transmit each of the transformed colour components;
a mechanism for controlling the display which comprises:
a reception means able to receive and to decode each of the transformed colour components; and
said means of controlling the columns of the matrix screen, connected at the output of the reception means, comprising:
a first sub-means capable of working out the control signal component to activate the subpixel corresponding to the colour yellow, by finding the minimum among the red and green colour components received and decoded;
a second sub-means capable of working out the control signal component to activate the subpixel corresponding to the colour cyan, by finding the minimum among the green and blue colour components received and decoded; and
a third sub-means capable of working out the control signal component to activate the subpixel corresponding to the colour magenta, by finding the minimum among the red and blue colour components received and decoded.

12. The Device according to claim 10, in which said processing system comprises:
a processing unit comprising:
the conversion means;
an intermediate unit connected at the output of the transformation means, able to determine on the basis of the three transformed colour components, forming three main colour components, three secondary colour components;
a transmission means capable of encoding the three main colour components, in particular by associating them with a secondary piece of information representing the value of at least one secondary colour component, and able to transmit the encoded three main colour components according to a standard called PPDS;
a means for controlling the display comprising:
a reception means able to receive the encoded three main colour components, and able to decode the main colour components received, by reading each piece of secondary information so as to generate a secondary signal representing the secondary colour components; and
said means of controlling the columns of the matrix screen, connected at the output of said reception means, comprising:
a first selector capable of working out the control signal component to activate the subpixel corresponding to the colour yellow by using the corresponding secondary signal to select the minimum among the decoded red and green colour components;
a second selector capable of working out the control signal component to activate the subpixel corresponding to the colour cyan by using the corresponding secondary signal to select the minimum among the decoded green and blue colour components; and
a third selector capable of working out the control signal component to activate the subpixel corresponding to the colour magenta by using the corresponding secondary signal to select the minimum among the red and blue colour components received and decoded.

13. Television set, characterized in that it incorporates a device according to claim 7.

14. Video display screen, characterized in that it incorporates a device according to any one of claim 7.

15. Microcomputer, characterized in that it incorporates a device according to any one of claim 7.

16. Mobile telephone, characterized in that it incorporates a device according to any one of claim 7.

17. Television set, characterized in that it incorporates a device according to claim 9.

18. Video display screen, characterized in that it incorporates a device according to any one of claim 9.

19. Microcomputer, characterized in that it incorporates a device according to any one of claim 9.

20. Mobile telephone, characterized in that it incorporates a device according to any one of claim 9.
